(19) United States
(12) Patent Application Publication
(10) Pub. No.: US 2005/0271582 A1
(43) Pub. Date: Dec. 8, 2005

(54) Method for synthesizing a crystalline metalloaluminosilicate by direct synthesis

(76) Inventors: Eva Barea, Valencia (ES); Vicente Fornes, Valencia (ES); Avelino Corma, Valencia (ES); Patrick Bourges, Lyon (FR); Nicolas Bats, Pomeys (FR); Emmanuelle Guillon, Saint Genis Laval (FR)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/125,339

(22) Filed: May 10, 2005

(30) Foreign Application Priority Data
May 10, 2004 (FR) 04/05.021

(51) Int. Cl. B01J 29/08; B01J 29/18; B01J 29/40; C01B 39/20; C01B 39/40; C01B 39/26

(52) U.S. Cl. 423/709; 423/713; 502/79; 502/85

(57) ABSTRACT

The invention concerns a method for preparing a crystalline metalloaluminosilicate by direct synthesis using at least one source of aluminium and, as the source of silicon and as the source of at least one other metal M, at least one lamellar siliceous material containing metals in its framework. The invention also concerns the novel solids obtained, in particular solids with a given zeolitic structure containing particular metals in its zeolitic framework.

### FIELD OF THE INVENTION

The invention concerns a method for preparing a crystalline metalloaluminosilicate by direct synthesis using at least one source of aluminium and, as the source of silicon and as the source of at least one other metal M, at least one lamellar siliceous material containing metals in its framework. The invention also concerns the novel solids obtained, in particular solids with a given zeolitic structure containing particular metals in its zeolitic framework.

### PRIOR ART

Zeolites are crystalline solids with a particular very fine and highly regular pore structure. Said solids have been known for a long period (middle of the 18^{th} century). Until about 1950, the many known natural zeolites were simply considered to be mineralogical curiosities. From then on, the first successes in the field of synthesis were recorded. The floodgates for said minerals were then opened and a great deal of research has had considerable success in synthesizing novel zeolites.

Currently, about forty natural zeolites are known along with between 150 and 200 synthetic zeolites less than ten of which are currently of industrial application.

The structure types of all of those zeolites are set out in the “Atlas of zeolite framework types”, 5^{th} revised edition (2001), Ch Baerlocher, W M Meier, D H Olson.

The term “zeolite” refers, according to that atlas, to a network of atoms with tetrahedral coordination MO₄. The MO₄ tetrahedra are connected together via their oxygen apex so that any two share a only one oxygen and that all of the oxygen atoms of the framework belong to two tetrahedra. In zeolites, this results in a very airy structure crisscrossed by very fine, very regular channels the openings of which are in the range 0.3 to 1.0 nm.

The most renowned zeolites are those which crystallize in the (Si, Al) (aluminosilicate) system, purely siliceous zeolites, zeolites which crystallize in the (Si, Ge) (silicogermanate) system, and zeolites which crystallize in the (Si, B) (borosilicate) system.

However, in some cases it is possible for particular metals to obtain other metallosilicate zeolites by direct synthesis; titanosilicates such as Ti-beta (Blasco T et al, Chem Commun, 2367-2368 (1996)), Zn-beta (Takewaki et al, Topics in Catalysis, 9, 35-42 (1999), chabazite Al—Co—P (Feng P Y, Nature, 388, 735-741 (1997)), beta Ga—Si (Reddy K S N et al, J. Incl Phenom Mol Recogn Chem) can be cited. However, the preparation methods used cannot incorporate all of the metals directly on synthesis. As an example, metals such as cobalt may precipitate at the zeolite synthesis pH.

The metal may also be introduced by post synthesis isomorphous substitution (European patent EP-A-0 146 384). Introduction is not always possible and depends on the nature of the metals. Aluminophosphates are solids which have been widely studied and which allow incorporation of various metals such as Co, Fe, Mg, Mn, Zn (for example to obtain Co—AlPO-FAU).

In general, hydrothermal synthesis of zeolites employs a mixture of compounds containing the metals of the zeolite (Si, Ge, Al, . . . ), alkali metal cations, water and often organic molecules which act as a template.

For silicoaluminous zeolites, the silicon and aluminium sources have been widely studied in the literature. As an example, the source of silicon incorporated into the step for preparing the mixture may be a silicate, silica gel, colloidal silica and/or silicic acid.

In United States patents U.S. Pat. No. 4,676,958 and U.S. Pat. No. 4,689,207, Zones et al used magadiite, a purely siliceous lamellar solid, as the silica source for zeolite synthesis. Those authors described the synthesis of zeolites such as ZSM-5, ZSM-48, ZSM-12, ZSM-39 and SSZ-15. Similarly, in British patent GB-A-2 125 390, the authors used synthesized siliceous magadiite or natural magadiite to synthesize ZSM-5 and MOR zeolites. Zones et al demonstrated that synthesized magadiite was particularly advantageous for zeolite synthesis on the grounds of cost.

Ko Y et al (Korean Journal of Chemical Engineering, 2001, 18(3), 392-395) demonstrated the use of Co²⁺ exchanged magadiite as the source of silicon and cobalt for the synthesis of Co-silcalite. Similarly, Younghee Ko et al (Microporous and Mesoporous Materials, 30(2-3) (1999), 213-218) used Mn²⁺ exchanged magadiite as the source of silicon and manganese for the synthesis of Mn-silicalite. In that case, the exchanged metal was not located in the framework of the lamellar solid and was susceptible of being exchanged with the template during synthesis of the zeolite.

Other studies have been based on re-crystallizing magadiite type solids (Si, Al) for the synthesis of MFI, FER and MEL zeolites (Microporous Mesoporous Materials 11 (1-2) (1997) 45-51; 22 (1998), 45-51). In this case, the lamellar solid used both as a source of silicon and aluminium was brought into direct contact with a template in the liquid phase or the gas phase. In those studies, the source of aluminium was limited to the aluminium incorporated into the lamellar solid which limited the introduction of aluminium into the final solid.

During the course of its research, the Applicant has directed its attention to solving the problem of cheaply and simply introducing any metal into the zeolite framework over the entire range of Si/Al and Si/metal ratios.

The invention is aimed at a direct synthesis method using a source of aluminium and a metallosiliceous lamellar solid as the source of silicon and of at least one other metal M to synthesize a crystalline metalloaluminosilicate. This method can incorporate any metal into the zeolitic framework with short crystallization times and variable Si/Al and Si/metal ratios.

The invention also pertains to novel solids prepared using said method.

The invention also pertains to novel zeolitic solids comprising particular metals in its framework.

### DESCRIPTION OF THE INVENTION

The invention concerns a method for preparing a crystalline metalloaluminosilicate by direct synthesis using at least one source of aluminium and, as the source of silicon and as the source of at least one other metal M, at least one lamellar siliceous material containing metals in its framework.

Said method comprises preparing a mixture containing at least one lamellar solid as the source of silicon and of at least one other metal M, at least one source of aluminium, water, optionally at least one organic compound as an organic template, optionally at least one zeolite seed and optionally at least one source of an alkaline cation. The steps of crystallization, nucleation and crystal growth result in the final crystalline solid.

The metal M is preferably selected from the group formed by boron, chromium, gallium, indium, nickel, zirconium, cobalt, titanium, copper, niobium, magnesium, zinc, manganese and germanium. More preferably, the metal M is selected from boron, gallium, indium, nickel, cobalt, copper, niobium, magnesium, zinc, manganese and germanium.

The invention also pertains to novel solids prepared using said method.

The invention also pertains to novel zeolitic solids comprising particular metals in its framework.

### Characterization Technique

The technique used to characterize the solids of the invention is X ray diffraction. In the following description, powder X ray analysis was carried out using a diffractometer operating in reflection mode and provided with a back monochromator using the copper radiation line (wavelength 1.5406 Å). The interplanar spacing d is deduced from the angular position using the Bragg relationship (2d₍ₕₖₗ₎*sin(θ)=n*λ). From the position of the diffraction peaks represented by the angle 2θ, the Bragg relationship is used to calculate the characteristic interplanar spacing dₕₖₗ of the sample. The measurement error Δ(dₕₖₗ) on dₕₖₗ is estimated using the Bragg relationship as a function of the absolute error Δ(2θ) made on the measurement of 2θ. An absolute error Δ(2θ) of ±0.2° is routinely accepted. Each crystalline solid has its own unique X ray diffraction diagram.

### DETAILED DESCRIPTION OF THE INVENTION

Lamellar Silicate Solids

Lamellar silicates used in the invention that can be cited are magadiite, natrosilite, kenyaite, magatite, nekoite, kanemite, okenite, dehayelite, macdonalite and rhodesite, and octosilicate. Preferably, magadiite or kenyaite is used. More preferably, magadiite is used.

Said lamellar silicate solids often exist naturally in a composition of the type AₓSi_{y}O_{z}.nH₂O. “A” may, for example, be the element sodium or potassium. Examples of such lamellar solids are Na₂Si₁₄O₂₉. 9H₂O for magadiite and Na₂Si₂₀O₄₁. 10H₂O for kenyaite. Said natural solids have the same composition as synthetic solids. Said solids often have a three-dimensional structure with Van der Waals type interactions between the sheets and also a low specific surface area.

The lamellar siliceous solids of the invention may be synthesized using any method that is known to the skilled person. The preparation method generally consists of a mixing step during which a mixture comprising an alkali metal, a source of silica SiO₂, water, an optional organic template and a crystallization step is prepared, and a crystallization step during which said mixture is maintained under conditions that allow the formation of a crystalline solid. The preferred alkali metal is sodium.

Synthesis methods that have been widely described in the literature which do not use an organic template and synthesis methods using an organic template should be distinguished from each other.

Preferably, in the context of the invention, a lamellar siliceous solid synthesized in the presence of an organic template is used.

The organic templates used to synthesize lamellar siliceous solids may be selected from the following non-exhaustive list: benzyltriethylammonium chloride, benzyltrimethylammonium chloride, dibenzyldimethylammonium chloride, N,N′-dimethylpiperazine, triethylamine or other quaternary compounds or heterocyclic amines, an alkylamine, a trialkylamine, a tetraalkyl ammonium compound and a trimethylhexamethylenediamine, said alkyl containing 1 to 12 carbon atoms.

Preferably, the organic template comprises at least one alcohol group and at least one amine group separated by a hydrocarbon chain. Advantageously, the organic template comprises a single alcohol group and a single amine group.

More preferably, the alcohol group is a terminal group of the organic template. In the same manner, the amine group is preferably a terminal group of the organic template. More preferably still, the two alcohol and amine groups are terminal groups of the organic template.

Preferably, the organic template comprises 1 to 20 carbon atoms.

The hydrocarbon chain separating the two amine and alcohol groups may comprise a linear, cyclic or aromatic alkyl group, preferably cyclic or aromatic.

Preferably, the organic template is selected from the group formed by tyramine, 4-aminophenol, trans-4-aminocyclohexanol and 2-(4-aminophenyl) ethanol.

The process for synthesizing the lamellar siliceous material comprises a mixing step during which a mixture comprising an alkali metal, a source of silica, water and the organic template is prepared.

The alkali metal A incorporated during the step for preparing the mixture may be lithium, potassium, sodium and/or calcium. Preferably, the alkali metal is sodium. The source of silica incorporated during the step for preparing the mixture may be a silicate, silica gel, colloidal silica and/or silicic acid.

Preferably, during mixing step i), at least one non siliceous metal, namely metal M, is also incorporated.

More preferably, the metal M is selected from the group formed by boron, chromium, gallium, indium, nickel, zirconium, cobalt, titanium, copper, niobium, magnesium, zinc, manganese and germanium. Still more preferably, the metal M is selected from boron, gallium, indium, nickel, cobalt, copper, niobium, magnesium, zinc, manganese and germanium.

Aluminium may also be incorporated in the form of Al₂O₃, Al(NO₃)₃), for example.

The metal M may be incorporated into the mixture in the oxidized form, XOn, or in any other form such as Co(CH₃COO)₂, Ti(EtO)₄, Ni(CH₃COO)₂, Zn(CH₃COO)₂, Cu(CH₃COO)₂, Cr(CH₃COO)₂, Zr(OH)₄, Na₂B₄O₇, Mg(CH₃COO)₂, Mn(CH₃COO)₂, Nb₂O₅ or GeO₂.

The composition of the mixture obtained during step i) may be described as follows:
SiO₂:xM⁺OH—:yH₂O:zA
in which:
x is generally in the range 0.1 to 1, preferably in the range 0.1 to 0.6;
y is more than 10;
z is in the range 0.05 to 3, preferably in the range 0.2 to 1.

The process for synthesizing the lamellar siliceous material comprises a step for crystallization during which said mixture is maintained under conditions that allow the formation of a crystalline solid.

The crystallization step is generally hydrothermal in nature. Said step may be carried out using any method known to the skilled person, preferably in an autoclave. The reaction mixture may or may not be vigorously stirred during the crystallization step.

Advantageously, during crystallization step ii), the mixture obtained is heated during step i) to a crystallization temperature in the range 100° C. to 200° C., preferably in the range 135° C. to 175° C., for a crystallization period in the range 1 to 20 days, preferably in the range 3 to 10 days.

Preferably, the product obtained in crystallization step ii) undergoes at least one of the following steps:
iii) a step for separating the solid from the crystallization mixture;
iv) a step for washing the solid; and
v) a step for drying said solid.

The crystalline solid is generally separated from the mixture using any method known to the skilled person, such as filtration. The solid is then washed with water, preferably deionized water.

Drying step v) is generally carried out at a temperature in the range 50° C. to 150° C. for a period of 12 to 20 hours.

Drying is preferably carried out at atmospheric pressure, but may be carried out under pressure.

The solids used for the preparation method of the invention are “as synthesized” solids (usually in the alkaline form) or they may have undergone modification treatments. The term “modification treatments” includes cationic exchange which places the solid in the acid form. Delamination or bridging of the solid may also be cited. The term “delamination treatment” means any treatment that can substantially reduce the forces of interaction between sheets to rupture cohesion between the sheets, to separate the sheets from each other and to disperse the sheets. The “delamination treatment” is preferably a mechanical treatment (vigorous stirring) or the use of ultrasound or any other method that is known to the skilled person falling within the above definition. “Bridging” consists of introducing pillars into the interlamellar spaces; it can create mesoporosity and increase the specific surface area.

The lamellar silicate solids used for the invention contain metals in the framework including at least one metal M, preferably selected from boron, chromium, gallium, indium, nickel, zirconium, cobalt, titanium, copper, niobium, magnesium, zinc, manganese and germanium, more preferably selected from boron, gallium, indium, nickel, cobalt, copper, niobium, magnesium, zinc, manganese and germanium.

The lamellar silicate solids may contain aluminium in this framework, in addition to the other metal or metals M. Preferably, the lamellar silicate solids contain only one metal M, and optionally aluminium, in the framework.

The metal may be introduced into the framework in any manner which is known to the skilled person, either by direct synthesis or by post-synthesis substitution. Preferably, the metal is introduced into the framework on synthesis of the lamellar solid.

The source of metal M used may be in the oxidized form, Mon, or in any other form, such as Co(CH₃COO)₂, Ti(EtO)₄, Ni(CH₃COO)₂, Zn(CH₃COO)₂, Cu(CH₃COO)₂, Cr(CH₃COO)₂, Zr(OH)₄, Na₂B₄O₇, Mg(CH₃COO)₂, Mn(CH₃COO)₂, Nb₂O₅ or GeO₂.

Aluminium Source

The aluminium source is preferably sodium aluminate or an aluminium salt, for example the chloride, nitrate, hydroxide or sulphate, an aluminium alkoxide or alumina itself, preferably in the hydrated or hydratable form, such as colloidal alumina, pseudoboehmite, gamma alumina or alpha or beta trihydrate. It is also possible to use mixtures of the sources cited above.

Seeds

It may be advantageous to add seeds to the reaction mixture to reduce the time required for the formation of nuclei and/or the total crystallization period. It may also be advantageous to use seeds to encourage the formation of the crystalline solid over that of impurities. Such seeds comprise crystalline solids, in particular crystals of the crystalline solid to be synthesized. The crystalline seeds are generally added in a proportion in the range 0.01% to 10% of the weight of the silicon source used in the reaction mixture.

Alkaline Cation

The alkaline cation is selected from the group formed by lithium, potassium, sodium and calcium. Sodium is preferred.

Organic Template

Zeolites crystallize from a gel which optionally contains an organic template. The “organic template” is a compound which contributes to the formation of a given zeolitic framework during the crystallization process and under the given synthesis conditions.

For a given structure type as defined in the Atlas of Zeolites (cited above), there are several associated zeolite types synthesized with different organic templates. “A” may be synthesized using different templates, and similarly the use of an organic template under different synthesis conditions can lead to a different zeolite, possibly with a different structure type.

The use of a particular template and zeolite synthesis processes are known to the skilled person. The review “Verified syntheses of zeolitic materials”, IZA Publications, H Robson, Ed, describes processes for synthesizing many verified zeolites published in the literature.

As an example, the zeolites EU-1 and ZSM-50, with structure type EUO, are respectively synthesized with the organic templates hexamethonium (HM) and dibenzyldimethylammonium (DBDMA).

Y zeolite, and more generally zeolites with structure type FAU, is synthesized in a hydrothermal medium in the absence of an organic template and in the presence of seeds. MOR zeolite is also synthesized in the absence of a template. Beta zeolite may be synthesized using tetraethylammonium hydroxide. ZSM-5 zeolite may be synthesized without a template but is preferably synthesized with tetrapropylammonium bromide (TPA) (industrial synthesis).

ZSM-22 zeolite may be synthesized with a diamino-octane type template.

Conditions for Synthesis

The conditions for synthesizing zeolites are widely known in the prior art. The gel is advantageously placed under hydrothermal conditions under autogenous reaction pressure, optionally adding a gas, for example nitrogen, at a temperature in the range 120° C. to 200° C. The time necessary to obtain crystallization generally varies between 1 hour and several months, depending on the composition of the reactants in the gel, the stirring conditions and the reaction temperature. Reaction generally takes place with or without stirring, preferably with stirring.

At the end of the reaction, the solid phase obtained is separated from the mixture using any method known to the skilled person, such as filtering. The solid is washed with water, preferably deionized water. The solid phase is then ready for subsequent steps such as drying, dehydration and calcining and/or ion exchange. Any conventional method which is known to the skilled person may be employed for said steps.

At the end of the reaction, the solid is filtered and washed; it is then said to be in its “as synthesized” form and is ready for subsequent steps such as drying, dehydration and calcining and/or ion exchange. For said steps, any of the conventional methods which are known to the skilled person may be employed.

The calcining step is advantageously carried out using one or more steps for heating to temperatures of 100° C. to 1000° C. for periods of a few hours to several days. Preferably, calcining is carried out in two consecutive heating steps, the first being carried out at a temperature in the range 100° C. to 300° C. and the second being carried out at a temperature in the range 400° C. to 700° C., the temperature being maintained for five to ten hours for each step.

The calcined forms of the solids contain no more organic template or a smaller quantity than in the “as synthesized form” because most of the organic substance is eliminated, generally by a heat treatment consisting of burning the organic substance in the presence of air.

Of the zeolite forms obtained by ion exchange, the ammonium form (NH₄⁺) is important, as it can readily be converted to its hydrogen form by calcining.

Modification treatments may also be applied to the calcined solid. The term “modification treatment” means all treatments such as steam treatments or acid attacks, which are known in the art.

Solids Obtained Using the Method

According to the preparation method of the invention, all zeolites containing metals other than aluminium in the framework may be synthesized. The term “metals other than aluminium” includes metals in addition to aluminum such as boron, chromium, gallium, indium, nickel, zirconium, cobalt, titanium, copper, niobium, magnesium, zinc, manganese and germanium, as a non exhaustive list. More preferably, the metal contained in the zeolite framework is selected from boron, gallium, indium, nickel, cobalt, copper, niobium, magnesium, zinc, manganese and germanium.

In a preferred mode of the invention, the solid obtained is a FAU type zeolite, more preferably a Y zeolite.

In accordance with a highly preferred mode, the metal M contained in the Y zeolite obtained is titanium. The Si/Ti ratio is generally in the range 10 to 1000, preferably in the range 15 to 80 or in the range 400 to 700.

According to a highly preferred mode, the Y zeolite obtained comprises nickel. The Si/Ni ratio is generally in the range 10 to 1000, preferably in the range 15 to 80 or in the range 400 to 700.

Novel Solids

The invention also concerns novel solid metalloaluminosilicates containing in their framework metals other than aluminium, such as boron, chromium, gallium, indium, nickel, zirconium, cobalt, titanium, copper, niobium, magnesium, zinc, manganese and germanium, in particular zeolites with:
a FAU structure crystallizing in the (Si, Al, M) system; with M=Co, Ni, Cu, Ti, Mn;
a beta structure crystallizing in the (Si, Al, M) system; with M=Co, Cu, Ni, Mn;
a MFI structure crystallizing in the (Si, Al, M) system; with M=Co, Ni, Zr, Cu, Mn, preferably with M=Co, Ni, Cu, Mn;
a MOR structure crystallizing in the (Si, Al, M) system; with M=Co, Ni, Zr, Cu, Mn, preferably with M=Co, Ni, Cu, Mn;
a EUO structure crystallizing in the (Si, Al, M) system; with M=Co, Ni, Cr, Zr, Ti, Mn;
a NES structure crystallizing in the (Si, Al, M) system; with M=Co, Ni, Cr, Zr, Ti, Mn;
a TON structure crystallizing in the (Si, Al, M) system; with M=Co, Ni, Cr, Zr, Ti, Mn.

A preferred zeolite is a zeolite with structure type FAU, more preferably a Y zeolite.

In one implementation, the Y zeolite obtained preferably comprises a metal selected from Co, Ni, Cu, Mn in the framework.

In accordance with a highly preferred mode, the metal M contained in the Y zeolite obtained is titanium alone. The Si/Ti ratio is generally in the range 10 to 1000, preferably in the range 15 to 80 or in the range 400 to 700.

In accordance with a highly preferred mode, the Y zeolite obtained comprises nickel. The Si/Ni ratio is generally in the range 10 to 1000, preferably in the range 15 to 80 or in the range 400 to 700.

### EXAMPLE 1

### Synthesis of Metalloaluminosilicate in the FAU System

The solid was synthesized from a gel prepared using the following molar compositions:
SiO₂/A₂O₃=5;
Na₂O/SiO₂=0.43;
H₂O/SiO₂=18.

This gel was brought into contact with seeds of FAU zeolite so that the final gel had the following composition:
SiO₂/Al₂O₃=10;
Na₂O/SiO₂=0.42;
H₂O/SiO₂=18.
   in which:
the Na source was sodium hydroxide (Scharlau);
the source of Al was sodium aluminate, 32.8% Na₂O, 54% Al₂O₃, 13.2% H₂O (Carlo Erba);
deionized water;
the source of Si was either magadiite with cobalt, copper, nickel or titanium in the framework or kenyaite with nickel, titanium, cobalt or copper in the framework.
   Preparation:

A solution containing 0.44 g of NaOH, 0.32 g of Al₂O₃ and 7.82 g of water was stirred vigorously (stirring rate=350 rpm). 2.57 g of magadiite (with Co, Cu, Ni or Ti) or kenyaite (with Ni, Ti, Co or Cu) was added to this solution. The mixture was stirred. FAU seeds were added to this mixture. The mixture was then stirred vigorously for 1 hour (stirring rate=350 rpm) and transferred into a propylene flask. The mixture was heated for 24 hours at 100° C. if the source of silicon was magadiite and for 48 hours at 100° C. if the source of silicon was kenyaite.

The product obtained after crystallization was centrifuged, washed with deionized water and dried overnight at 100° C.

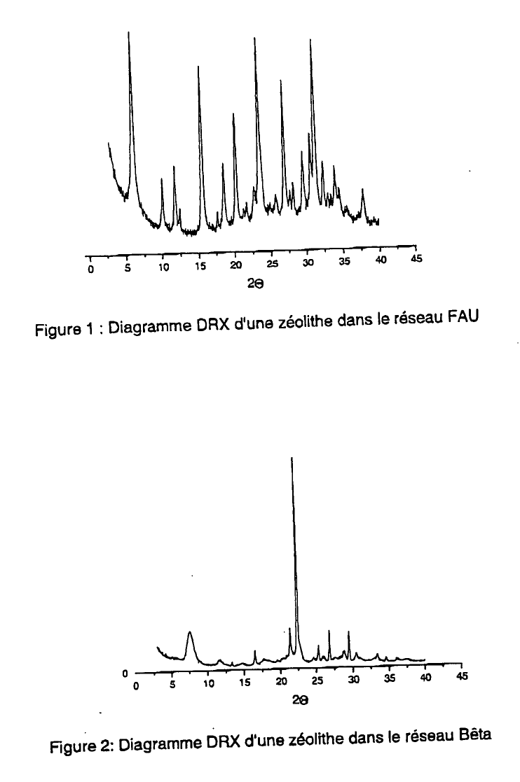

The Si/Al and Si/M ratios for the solids obtained are shown in Table 1. The resultant solids had an X-ray diffraction diagram as shown in FIG. 1, similar to that of an FAU zeolite.

TABLE 1

| Source of Si, nature of metal, | Si/Al of solid | Si/metal of solid |
|---|---|---|
| Si/M ratio in lamellar material | obtained | obtained |
| Magadiite with Co | 4.4 | 28.5 |
| Si/Co = 50 | | |
| Magadiite with Co | 4.9 | 30.0 |
| Si/Co = 30 | | |
| Magadiite with Ni | 3.9 | 36.4 |
| Si/Ni = 50 | | |
| Magadiite with Ni | 5.6 | 501.0 |
| Si/Ni = 650 | | |
| Magadiite with Cu | 4.1 | 114.0 |
| Si/Cu = 50 | | |
| Magadiite with Ti | 4.0 | 16.0 |
| Si/Ti = 100 | | |
| Magadiite with Ti | 4.0 | 520.0 |
| Si/Ti = 1000 | | |
| Kenyaite with Co | 4.1 | 20.0 |
| Si/Co = 30 | | |
| Kenyaite with Ti | 4.1 | 32.0 |
| Si/Ti = 100 | | |
| Kenyaite with Cu | 4.2 | 18.0 |
| Si/Cu = 30 | | |
| Kenyaite with Ni | 4.1 | 41.0 |
| Si/Ni = 50 | | |
| Kenyaite with | 4.0 | 480.0 |
| Si/Ni = 650 | | |

### EXAMPLE 2

### Synthesis of Metalloaluminosilicate in the Beta System

The solid was synthesized from a gel prepared using the following molar compositions:
SiO₂/Al₂O₃=50;
TEAOH/SiO₂=0.5;
NaOH/SiO₂=0.02;
H₂O/SiO₂=15;
(Na+K)/SiO₂=0.12;
K/(Na+K)=0.33.
   the source of Si was a magadiite with Co or Mn in the framework;
   tetraethyl ammonium hydroxide (TEAOH, 35% from Aldrich, was the organic template;
   the source of sodium Na was sodium hydroxide (Scharlau) and 99% NaCl (Prolabo);
   the source of Al was sodium aluminate, 32.8% Na₂O, 54% Al₂O₃, 13.2% H₂O (Carlo Erba);
   the source of K was 99.5% KCl (Scharlau);
   the water was deionized water.
      Preparation:

0.088 g of NaCl and 0.214 g of KCl were diluted in a solution of 15.4 g of tetraethylammonium hydroxide and 8.58 g of water.

4.402 g of magadiite containing a metal M (Co, Mn) was added, with stirring (stirring rate=350 rpm). After 30 minutes, a solution comprising 0.275 g of sodium aluminate, 0.056 g of NaOH and 2.92 g of water was added to the mixture. The mixture was stirred for 30 minutes.

The gel obtained was transferred to a Teflon sleeve of an autoclave and heated to 140° C. The autoclave was stirred continuously, the longitudinal axis of the autoclave rotating at a rate of about 60 rpm in a plane perpendicular to the rotational axis for 15 days. The product obtained after crystallization was centrifuged and the recovered solid was washed with distilled water, the solid was dried overnight at 100° C.

The solids obtained according to the preparation of the invention had an X ray diffraction diagramidentical to that shown in FIG. 2, similar to that of a beta zeolite.

Table 2 shows the compositions of Si, Al and Co for the case in which the solid contained cobalt.

TABLE 2

| Source of Si, nature of metal, | Si/Al of solid | Si/metal of solid |
|---|---|---|
| Si/M ratio in lamellar material | obtained | obtained |
| Magadiite with Co | 13.6 | 15.2 |
| Si/Co = 30 | | |
| Magadiite with Co | 13.6 | 23.4 |
| Si/Co = 40 | | |
| Magadiite with Co | 11.3 | 41.2 |
| Si/Co = 50 | | |
| Magadiite with Mn | 10.7 | 52.7 |
| Si/Mn = 50 | | |

### EXAMPLE 3

### Synthesis of Metalloaluminosilicate in the MFI System

The solid was synthesized from a gel prepared using the following molar compositions:
SiO₂/Al₂O₃=100;
NaOH/SiO₂=0.15;
H₂O/SiO₂=34.5;
TPA/SiO₂=0.31.
   in which:
the source of Al₂O₃ was Al₂(SO₄)₃₀.18H₂O (Merck);
the source of SiO₂ was magadiite with metals in the framework (Co, Ni, Cu, Mn)
the organic template was tetrapropylammonium bromide (TPA-Br), 99% (Aldrich);
the source of sodium Na was sodium hydroxide (Scharlau);
the water was deionized water.
   Preparation:

15.19 g of magadiite containing a metal M (Co, Ni Cu, Mn), 151.19 g of water, 1.68 g of Al₂(SO₄)₃. 18H₂O, 1.519 g of NaOH and 20.112 g of tetrapropylammonium bromide were mixed, with stirring, for one hour. The gel obtained was transferred to a Teflon sleeve of an autoclave and heated to 175° C. without rotating for 6 days.

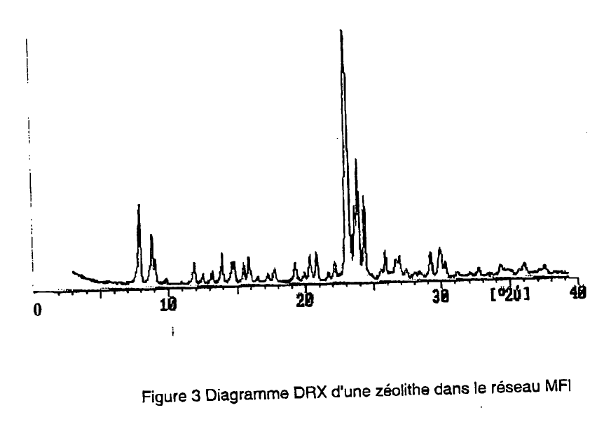

The product obtained after crystallization was centrifuged and the recovered solid was washed with distilled water; the solid was dried overnight at 100° C. The resultant products had an X-ray diffraction diagram according to FIG. 3, similar to that of an MFI zeolite.

TABLE 3

| Source of Si, nature of metal, | Si/Al of solid | Si/metal of solid |
|---|---|---|
| Si/M ratio in lamellar material | obtained | obtained |
| Magadiite with Ni | 28.0 | 41.1 |
| Si/Ni = 50 | | |
| Magadiite with Co | 17.0 | 30 |
| Si/Co = 50 | | |
| Magadiite with Mn | 10 | 124 |
| Si/Mn = 50 | | |
| Magadiite with Cu | 41.8 | 80.6 |
| Si/Cu = 50 | | |

The resultant zeolites of this invention are useful as adsorbents and catalysts. As adsorbents, simple tests or calculations can be made of those skilled in zeolite chemistry to determine which molecules can be adsorbed.

With respect to the novel zeolites of this invention, the metal M cannot be introduced into the zeolite by previously known methods.

The preceding examples can be repeated with similar success by substituting the generically or specifically described reactants and/or operating conditions of this invention for those used in the preceding examples.

The entire disclosures of all applications, patents and publications, cited herein and of corresponding French application No. 04/05.021, filed May 10, 2004 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. A method for preparing a crystalline metalloaluminosilicate by direct synthesis using at least one source of aluminium and, as a source of silicon and as a source of at least one other metal M selected from the group consisting of by boron, chromium, gallium, indium, nickel, zirconium, cobalt, titanium, copper, niobium, magnesium, zinc, manganese and germanium, at least one lamellar siliceous material containing said at least one other metal in its framework.

2. A preparation method according to claim 1, comprising a step for mixing at least one lamellar solid as the source of silicon and as the source of at least one other metal M with at least one source of aluminium, and water, a crystallization step, a nucleation step and a crystal growth step.

3. A preparation method according to claim 2, in which the mixture comprises at least one organic compound as an organic template.

4. A preparation method according to claim 2, in which the mixture comprises at least one zeolite seed.

5. A preparation method according to claim 2, in which the mixture comprises at least one source of an alkaline cation.

6. A preparation method according to claim 1, in which the metal M is selected from the group consisting of boron, gallium, indium, nickel, cobalt, copper, niobium, magnesium, zinc, manganese and germanium.

7. A preparation method according to claim 1, in which the lamellar siliceous material is magadiite or kenyaite.

8. A preparation method according to claim 7, in which the lamellar siliceous material is magadiite.

9. A preparation method according to claim 1, in which the lamellar siliceous material is synthesized in the presence of an organic template.

10. A preparation method according to claim 9, in which the organic template comprises at least one alcohol group and at least one amine group separated by a hydrocarbon chain.

11. A preparation method according to claim 10, in which the organic template comprises a single alcohol group and a single amine group.

12. A preparation method according to claim 11, in which the alcohol group is a terminal group of the organic template and/or the amine group is a terminal group of the organic template.

13. A preparation method according to claim 9, in which the organic template comprises 1 to 20 carbon atoms.

14. A preparation method according to claim 1, in which the lamellar siliceous material is cationically exchanged, bridged or delaminated.

15. A solid metalloaluminosilicate, containing at least one metal M in its framework selected from the group consisting of boron, chromium, gallium, indium, nickel, zirconium, cobalt, titanium, copper, niobium, magnesium, zinc, manganese and germanium.

16. A solid metalloaluminosilicate according to claim 15, containing in its framework at least one metal M selected from the group consisting of boron, gallium, indium, nickel, cobalt, copper, niobium, magnesium, zinc, manganese and germanium.

17. A solid metalloaluminosilicate according to claim 15, with a FAU type structure.

18. A solid metalloaluminosilicate according to claim 15 comprising metals in its zeolitic framework, selected from the group consisting of zeolites with structure type FAU crystallizing in the (Si, Al, M) system in which M designates a metal selected from the group consisting of Co, Ni, Cu, Ti, and Mn.

19. A solid metalloaluminosilicate according to claim 15 comprising metals in its zeolitic framework, selected from the group consisting of zeolites with structure type beta crystallizing in the (Si, Al, M) system in which M designates a metal selected from the group consisting of Co, Cu, Ni, and Mn.

20. A solid metalloaluminosilicate according to claim 15 comprising metals in its zeolitic framework, selected from the group consisting of zeolites with structure type MFI or MOR crystallizing in the (Si, Al, M) system in which M designates a metal selected from the group consisting of Co, Ni, Cu, Zr, and Mn.

21. A solid metalloaluminosilicate according to claim 15 comprising metals in its zeolitic framework, selected from the group consisting of zeolites with structure type EUO, NES or TON crystallizing in the (Si, Al, M) system in which M designates a metal selected from the group consisting of Co, Ni, Cr, Zr, Ti, and Mn.

22. A solid metalloaluminosilicate according to claim 17, which is a Y zeolite.

23. A metalloaluminosilicate according to claim 22, which contains Ni in a Si/Ni ratio in the range 10 to 1000.

24. A solid metalloaluminosilicate according to claim 22, which contains Ti as the sole metal M, in a Si/Ti ratio in the range 10 to 1000.
